(19) United States
(12) Patent Application Publication
(10) Pub. No.: US 2012/0287303 A1
(43) Pub. Date: Nov. 15, 2012

(54) SOUND SEPARATING DEVICE AND CAMERA UNIT INCLUDING THE SAME

(75) Inventors: Syuzi Umeda, Osaka (JP); Ryusuke Horibe, Osaka (JP); Hiroshi Okuno, Osaka (JP); Toru Takahashi, Osaka (JP)

(73) Assignee: Funai Electric Co., Ltd., Osaka (JP)

(21) Appl. No.: 13/468,174

(22) Filed: May 10, 2012

(30) Foreign Application Priority Data
May 10, 2011 (JP) 2011-105404

(51) Int. Cl. H04N 5/225; H04R 3/00

(52) U.S. Cl. 348/231.4; 381/92; 348/207.99; 348/E05.024

(57) ABSTRACT

A sound separating device includes a first microphone that converts input sound into a first sound signal, a second microphone that converts input sound into a second sound signal and has characteristics of a larger distance attenuation ratio than the first microphone, and a sound signal processing portion that optimizes a separating matrix by independent component analysis based on the first sound signal and the second sound signal that are supplied, and uses the optimized separating matrix so as to separate a third sound signal as a sound signal from a near field sound source and to separate a fourth sound signal as a sound signal from a far field sound source.

### CROSS-REFERENCE TO RELATED APPLICATIONS

This application is based on Japanese Patent Application No. 2011-105404 filed on May 10, 2011, the contents of which are hereby incorporated by reference.

### BACKGROUND OF THE INVENTION

1. Field of the Invention

The present invention relates to a sound separating device that separates and extracts only near field sound or far field sound from mixed sound in which the near field sound and the far field sound are mixed. In addition, the present invention relates to a camera unit including the sound separating device.

2. Description of Related Art

Conventionally, a technique of independent component analysis (ICA) is used for separating and extracting sound from a sound source to be detected (target sound) from mixed sound in which the target sound and noise from a noise source are mixed. The sound source to be detected is, for example, a sound source that is the voice of a person speaking.

For instance, JP-A-2005-227512 discloses a sound signal processing device capable of performing blind sound source separation (BBS) in real time. In this sound signal processing device, mixed sound is input to a non-directional microphone, and either one of sound from a sound source to be detected and noise from a noise source is mainly input to a unidirectional microphone. Thus, the blind sound source separation can be performed in real time. Note that the blind sound source separation means a method including steps of optimizing a separating matrix for separating target sound from mixed sound by using the ICA technique, and separating and extracting the target sound from the mixed sound using the optimized separating matrix.

### SUMMARY OF THE INVENTION

It is an object of the present invention to provide a sound separating device capable of appropriately separating sound from a near field sound source from sound from a far field sound source. In addition, another object of the present invention is to provide a camera unit including the sound separating device so as to appropriately record target sound by removing noise generated in a vicinity of the camera unit.

In order to achieve the above-mentioned object, a sound separating device of the present invention includes a first microphone that converts input sound into a first sound signal, a second microphone that converts input sound into a second sound signal and has characteristics of a larger distance attenuation ratio than the first microphone, and a sound signal processing portion that optimizes a separating matrix by independent component analysis based on the first sound signal and the second sound signal that are supplied, and uses the optimized separating matrix so as to separate a third sound signal as a sound signal from a near field sound source and to separate a fourth sound signal as a sound signal from a far field sound source.

According to this structure, it is possible to appropriately separate sound from a near field sound source from sound from a far field sound source. Therefore, the present invention is suitable, for example, for a camera unit or the like for taking a moving image and recording sound simultaneously.

In the sound separating device having the above-mentioned structure, it is preferred that the second microphone is a differential microphone, and for example, a differential microphone having first-order gradient characteristics can be used. According to this structure, it is possible to realize a sound separating device capable of accurately separating and extracting only sound from a near field sound source or from a far field sound source.

In the sound separating device having the above-mentioned structure, if the second microphone is a differential microphone, it is preferred that the differential microphone includes only one diaphragm vibrated by sound pressure. According to this structure, the second microphone can be downsized, and the sound separating device can be easily mounted in electronic devices.

In the sound separating device having the above-mentioned structure, the first microphone may be a non-directional microphone. This structure is suitable for a case where a wide range is assumed as a region where the far field sound source exists.

In the sound separating device having the above-mentioned structure, the first microphone and the second microphone are formed in one package. According to this structure, a distance between two microphones can be very small, and hence the target sound can be separated and extracted more appropriately.

In addition, in order to achieve the above-mentioned object, a camera unit of the present invention includes a sound separating device having the above-mentioned structure. Specifically, it is preferred that the camera unit having the above-mentioned structure further includes an image pickup portion that photographs a subject and converts the photographed information into an image signal, and a storing portion that stores the image signal and the fourth sound signal.

In this structure, when a moving image is taken with the camera unit, it is possible to remove noise generated from a main body of the camera unit and its vicinity so as to appropriately record ambient sound apart from the camera unit as the target sound.

In the camera unit having the above-mentioned structure, it is possible that the image pickup portion includes a lens portion that forms an image of incident light from the subject direction and a lens driving portion that drives a movable lens included in the lens portion, and the sound signal processing portion performs optimization of the separating matrix in a period while the lens driving portion is operating, and does not perform the optimization of the separating matrix in a period while the lens driving portion does not operate.

According to this structure, it is possible to effectively separate and remove sound generated particularly in the lens driving portion among sound generated in a vicinity of the camera unit as noise so as to obtain the target sound.

According to the sound separating device of the present invention, sound from a near field sound source can be appropriately separated from sound from a far field sound source. In addition, the camera unit equipped with the sound separating device of the present invention can remove noise such as mechanical noise generated in a vicinity of the camera unit so as to appropriately record the target sound (ambient sound apart from the camera unit).

### BRIEF DESCRIPTION OF THE DRAWINGS

FIG. 1 is a block diagram illustrating a structure of a camera unit of an embodiment of the present invention.

FIG. 2 is a schematic perspective view illustrating a structure of the camera unit of the embodiment of the present invention.

FIG. 3A is a schematic perspective view illustrating a structure of a near field microphone incorporated in the camera unit of the embodiment of the present invention.

FIG. 3B is a schematic cross-sectional view taken along the line A-A in FIG. 3A.

FIG. 4A is a schematic perspective view illustrating a structure of a far field microphone incorporated in the camera unit of the embodiment of the present invention.

FIG. 4B is a schematic cross-sectional view taken along the line B-B in FIG. 4A.

FIG. 5 is a graph illustrating a relationship between sound pressure P and a distance R from a sound source.

FIG. 6A is a diagram illustrating directivity characteristics of the near field microphone.

FIG. 6B is a diagram illustrating directivity characteristics of the far field microphone.

FIG. 7 is a graph for explaining distance attenuation characteristics of the near field microphone and the far field microphone.

FIG. 8 is a diagram illustrating directivity characteristics of the microphones incorporated in the camera unit of the embodiment of the present invention.

FIG. 9 is a diagram for explaining an exemplary variation of the embodiment of the present invention, and is a schematic cross-sectional view illustrating a structure in which the near field microphone and the far field microphone are formed in one package.

FIG. 10 is a diagram for explaining an exemplary variation of the embodiment of the present invention, and is a block diagram of a sound separating device having a structure in which execution or non-execution of optimization of a separating matrix can be switched based on a drive or non-drive state of a lens driving portion.

FIG. 11 is a diagram illustrating directivity characteristics of the microphones in a case where a non-directional microphone and a unidirectional microphone are mounted in the camera unit.

### DETAILED DESCRIPTION OF THE PREFERRED EMBODIMENTS

Prior to describing an embodiment of the present invention, in order to facilitate understanding of the present invention, an object of the present invention is described in detail below. In recent years, there are used many electronic devices capable of taking moving images (for example, a portable video camera device, a mobile phone, a portable game machine, and the like). These electronic devices usually have a camera unit capable of taking moving images and recording sounds simultaneously. This camera unit usually has an automatic focus function for adjusting focus on a subject and a zoom function for changing magnification of the subject.

When performing the automatic focus function or the zoom function, a lens system is moved by a DC motor, a stepping motor, or the like. In this case, when the lens system is moved, a motor noise or a noise due to another mechanical system may be generated. In addition, when the camera unit takes a moving image, a focus process and a zoom process always work. Therefore, a motor noise or an operating noise may be recorded. In addition, other than these noises, an undesired noise (for example, a noise when an operator operates the camera) may be recorded. It is desired that such undesired noise not be recorded to the extent possible.

In this viewpoint, it is considered to apply the technique of a sound signal processing device as described in JP-A-2005-227512, for example, to the camera unit, so that only target sound without a noise is record. However, when the technique of JP-A-2005-227512 is applied to the camera unit for the above-mentioned purpose, the following problem occurs.

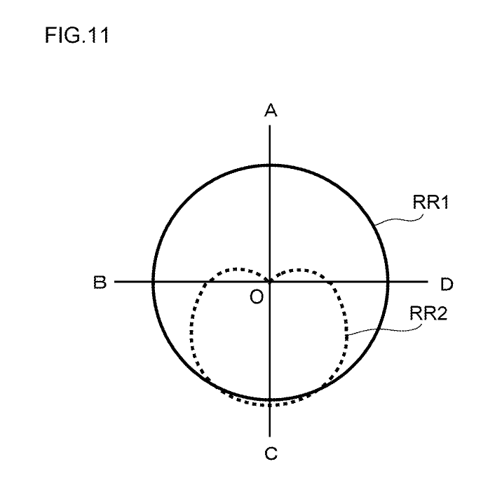

FIG. 11 is a diagram illustrating directivity characteristics of the microphones in a case where a non-directional microphone and a unidirectional microphone are mounted in the camera unit. In FIG. 11, the camera unit is located at the center O. In FIG. 11, a region (circular region) RR1 surrounded by the solid line indicates directivity characteristics of the non-directional microphone in which sounds from all directions can be uniformly collected with good sensitivity. In addition, a region (heart-shaped region) RR2 surrounded by the broken line indicates directivity characteristics of the unidirectional microphone, in which sound from a specific direction with respect to the center O (direction C) can be collected with good sensitivity.

When a moving image is taken, sound generated at a position away from the camera unit such as the voice of the subject, is usually the target sound (sound to be detected), while sound generated in a vicinity of the camera unit (the above-mentioned motor noise, operating noise when the lens system is moved, operation noise, or the like) is usually undesired sound (noise) in many cases.

The unidirectional microphone has characteristics of collecting sound from a specific direction, and it can collect not only sound from a sound source in the vicinity of the camera unit but also sound from a sound source positioned away from the camera unit in the direction of the directivity. In the same manner as a conventional technique, it is considered to locate a motor of the camera unit in the direction where sensitivity of the directivity of the unidirectional microphone is good so that noise from a noise source is mainly collected by the unidirectional microphone. However, in this case, the unidirectional microphone also collects sound in the far field in the same direction. Therefore, in this structure, when sound source separation is performed, there is a problem that some sound in the far field remains as noise, or a separating matrix is not converged so that separation cannot be performed.

In view of the above discussion, it is an object of the present invention to provide a sound separating device that can appropriately separate sound from a near field sound source from sound from a far field sound source. In addition, it is another object of the present invention to provide a camera unit including the sound separating device and capable of recording a target sound appropriately by removing noise generated in a vicinity of the camera unit.

Hereinafter, an embodiment of the sound separating device according to the present invention and the camera unit including the device is described in detail with reference to the attached drawings.

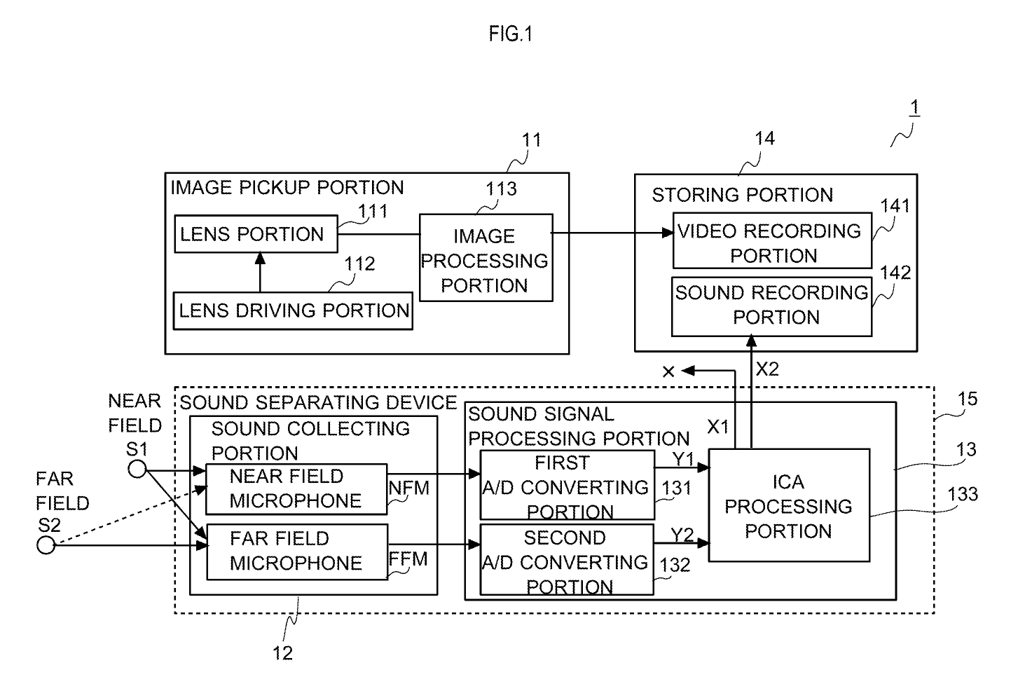

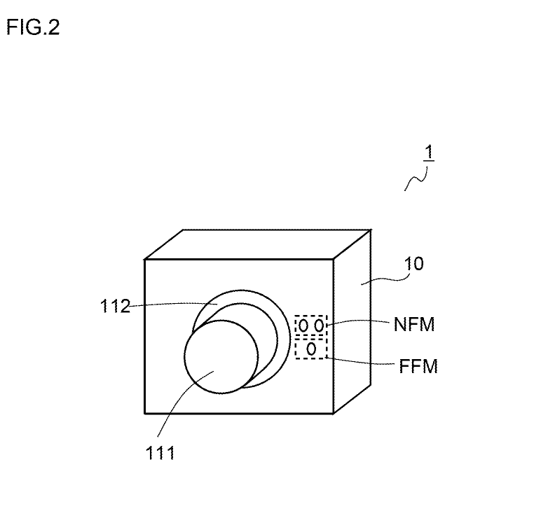

FIG. 1 is a block diagram illustrating a structure of the camera unit of the embodiment of the present invention. FIG. 2 is a schematic perspective view illustrating a structure of the camera unit of the embodiment of the present invention. As illustrated in FIG. 1, the camera unit 1 of this embodiment 1 includes an image pickup portion 11 capable of taking moving images, a sound collecting portion 12 capable of collecting ambient sound when the moving image is taken, a sound signal processing portion 13 that processes sound collected by the sound collecting portion 12, and a storing portion 14 that records an image signal output from the image pickup portion 11 and records a sound signal output from the sound signal processing portion 13.

Note that a part 15 (surrounded by a broken line in FIG. 1) including the sound collecting portion 12 and the sound signal processing portion 13 is an embodiment of the sound separating device according to the present invention.

The image pickup portion 11 is equipped with a lens portion 111 that is attached to a main body 10 of the camera unit 1 so as to form an image of incident light from the direction of the subject (see FIG. 2). This lens portion 111 may be constituted of a single lens or a plurality of lenses. In addition, the lens portion 111 includes a movable lens that can move in an optical axis direction so that automatic focus adjustment and zoom adjustment can be performed.

The image pickup portion 11 is equipped with a lens driving portion 112 that drives the movable lens included in the lens portion 111. FIG. 2 illustrates a part of the lens driving portion 112. The lens driving portion 112 includes a drive source such as a DC motor, a stepping motor, an ultrasonic motor, or a piezoelectric element. Then, the lens driving portion 112 drives the drive source when the focus adjustment or the zoom adjustment is performed, so that a holder holding the movable lens is moved along a guide. An operation of this lens driving portion 112 is controlled by a control portion (not shown). Note that when the lens driving portion 112 is driven, a motor noise or an operating noise due to movement of the holder is generated.

The image pickup portion 11 is equipped with an image processing portion 113. The image processing portion 113 has an imaging surface disposed at a position where an image of incident light from the direction of the subject is formed by the lens portion 111. The image processing portion 113 is disposed for performing photoelectric conversion of the incident light so as to output the image signal. This image processing portion 113 is constituted of a charge coupled device (CCD) image sensor or a complementary metal oxide semiconductor (CMOS) image sensor, for example. The image signal output from the image processing portion 113 is sent to a video recording portion 141 of the storing portion 14 so that a video recording process is performed.

The sound collecting portion 12 includes a near field microphone NFM that mainly collects sound from near field sound sources (sound sources close to the camera unit 1) and converts the sound into an electric signal, and a far field microphone FFM that converts mixed sound of the sound from the near field sound sources and sound from far field sound sources (corresponding to sound sources other than the near field sound sources in this embodiment) into an electric signal.

As the far field microphone FFM, a microphone capable of collecting the sound of the subject is used. For instance, a non-directional microphone can be selected. In addition, as the near field microphone NFM, a microphone having good distance attenuation characteristics is used. As the near field microphone NFM, for example, a differential microphone having gradient characteristics of a first or higher order gradient is used, and it is preferred to select a microphone that suppresses far field sound and collects mainly near field sound. Note that the far field microphone FFM is an example of the first microphone of the present invention, and the near field microphone NFM is an example of the second microphone of the present invention.

The near field microphone NFM and the far field microphone FFM are disposed close to each other and mounted on a mounting substrate (not shown) in the main body 10 of the camera unit 1. In FIG. 2, because these two microphones are inside the main body 10, they are indicated by broken lines. The main body 10 of the camera unit 1 is provided with openings for the microphones NFM and FFM to receive sound. Positions where the microphones NFM and FFM are located are determined appropriately. In this embodiment, these microphones NFM and FFM are disposed at the front side of the main body 10. Here, it is preferred that the differential microphone used as the near field microphone NFM be disposed so that the direction of highest sensitivity of the directivity characteristics (main axis direction) becomes the direction of the lens driving portion. Thus, the near field microphone NFM can effectively collect operating noise of the lens driving portion.

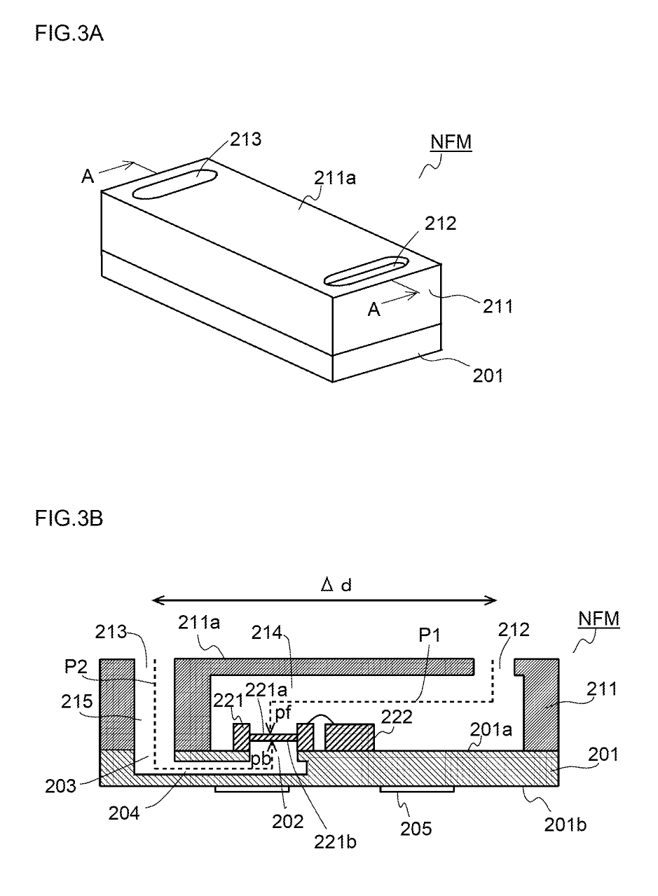

FIG. 3A is a schematic perspective view of a structure of an example of the near field microphone incorporated in the camera unit of the embodiment of the present invention. FIG. 3B is a schematic cross sectional view taken along the line A-A in FIG. 3A. The near field microphone NFM has a structure in which a cover 211 is attached to a microphone substrate 201 on which a micro electro mechanical system (MEMS) chip 221 and an application specific integrated circuit (ASIC) 222 are mounted.

The MEMS chip 221 is a capacitive microphone chip manufactured by semiconductor process technology for processing silicon (Si). The MEMS chip 221 includes a diaphragm 221a that is displaced by an input sound pressure, and a fixed electrode 221b disposed to be opposed to the diaphragm 221a. A change of the input sound pressure causes a change of distance between the diaphragm 221a and the fixed electrode 221b and thus a change of capacitance. The MEMS chip 221 is constituted so that sound pressure is transmitted to both sides (upper side and lower side) of the diaphragm 221a. The fixed electrode 221b is provided with a plurality of air holes penetrating from the upper side to the lower side so as not to be vibrated by the sound pressure. In addition, the ASIC 222 is an integrated circuit including a circuit for converting a capacitance change of the MEMS chip 221 into an electric signal (sound signal), and a power supply circuit for applying a bias voltage to the diaphragm 221a or the fixed electrode 221b.

Note that this embodiment has a structure in which the ASIC 222 is disposed separately from the MEMS chip 221. However, without limiting to this structure, the integrated circuit mounted on the ASIC 222 may be formed in a monolithic manner on a silicon substrate constituting the MEMS chip 221.

A first opening 202 and a second opening 203 are formed on a substrate upper surface 201a of the microphone substrate 201, on which the MEMS chip 221 and the ASIC 222 are mounted. The first opening 202 and the second opening 203 communicate with each other through a substrate internal space 204. Note that this microphone substrate 201 may be obtained by laminating a plurality of substrates.

The MEMS chip 221 is disposed so that the diaphragm 221a is substantially parallel to the microphone substrate 201 and that the first opening 202 is blocked from the substrate upper surface 201a side. In addition, a connection terminal 205 for external connection is formed on a lower surface 201b of the microphone substrate 201.

A first sound hole 212 is formed in an upper surface 211a of the cover 211 at an end portion in the longitudinal direction while a second sound hole 213 is formed at the other end portion. Note that in this embodiment the two sound holes 212 and 213 have a long hole shape, but this shape is not a limitation and can be modified as necessary.

In addition, a first space portion 214 communicating to the first sound hole 212 and a second space portion 215 that is separated from the first space portion 214 and communicates to the second sound hole 213 are formed in the cover 211. The cover 211 is placed on the microphone substrate 201 so that the first space portion 214 is separated from the substrate internal space 204 by the MEMS chip 221. In addition, the cover 211 is placed on the microphone substrate 201 so that the second space portion 215 communicates to substrate internal space 204 via the second opening 203.

The near field microphone NFM having the above-mentioned structure has a first sound channel P1 for introducing external sound from the first sound hole 212 to an upper surface of the diaphragm 221a via the first space portion 214. In addition, the near field microphone NFM has a second sound channel P2 for introducing external sound from the second sound hole 213 to a lower surface of the diaphragm 221a via the second space portion 215, the second opening 203, the substrate internal space 204, and the first opening 202, in this order.

Then, the near field microphone NFM vibrates the diaphragm 221a by a difference between a sound pressure pf applied to the upper surface of the diaphragm 221a and a sound pressure pb applied to the lower surface of the diaphragm 221a, so as to convert input sound into an electric signal (sound signal). In other words, the near field microphone NFM is constituted as a differential microphone of first-order gradient. Note that the sound channel P1 and the sound channel P2 have substantially the same length so that a phase difference is not generated between the both sound channels in this embodiment, though this structure is not a limitation.

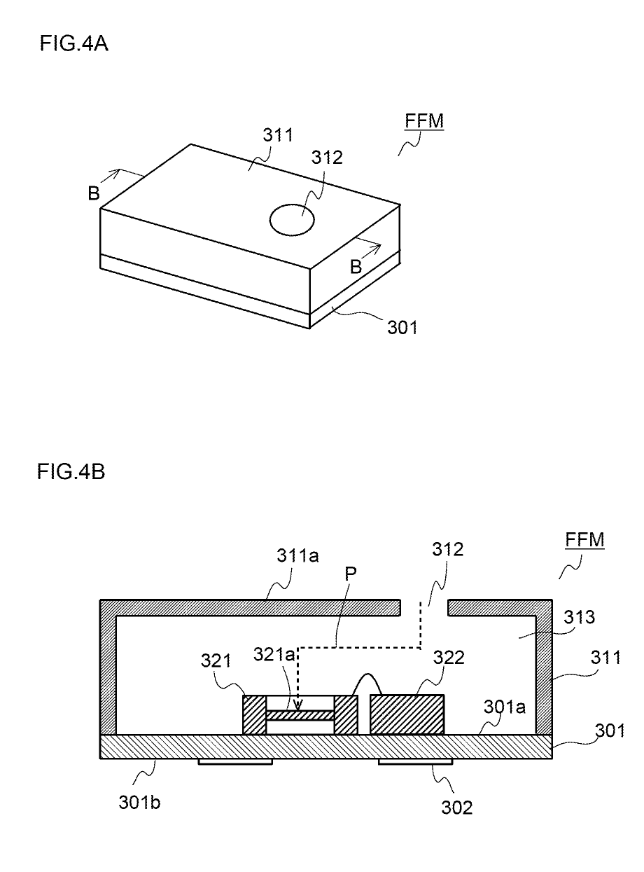

FIG. 4A is a schematic perspective view illustrating a structure of the far field microphone incorporated in the camera unit of the embodiment of the present invention. FIG. 4B is a schematic cross sectional view taken along the line B-B in FIG. 4A.

The far field microphone FFM has a structure in which a MEMS chip 321 and an ASIC 322 are mounted on an upper surface 301a of a microphone substrate 301, and a cover 311 is placed on the microphone substrate 301 so as to cover the MEMS chip 321 and the ASIC 322. A connection terminal 302 for external connection is formed on a lower surface 301b of the microphone substrate 301.

A sound hole 312 is formed in an upper surface 311a of the cover 311, and a space portion 313 is formed so as to communicate to the sound hole 312. The far field microphone FFM having this structure has a sound channel P for introducing external sound from the sound hole 312 to an upper surface of a diaphragm 321a via the space portion 313. In addition, the lower surface side of the diaphragm 321a is blocked by the microphone substrate 301a so that a closed space is formed.

Note that structures of the MEMS chip 321 and the ASIC 322 are the same as those of the near field microphone NFM, and hence description thereof is omitted.

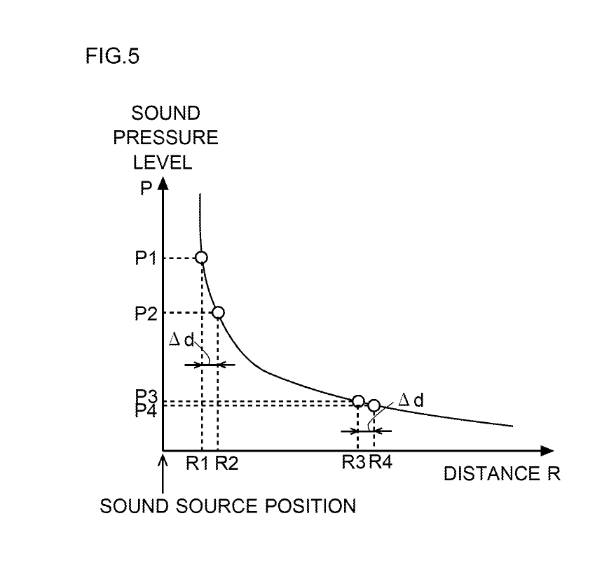

Here, characteristics of the near field microphone NFM and the far field microphone FFM are described. Prior to this description, properties of a sound wave are described. FIG. 5 is a graph illustrating a relationship between sound pressure P and a distance R from a sound source. As illustrated in FIG. 5, the sound wave is attenuated so that the sound pressure (intensity or amplitude of the sound wave) is lowered as it propagates in a medium such as air. The sound pressure is attenuated in proportion to the distance from the sound source, and hence a relationship between the sound pressure P and the distance R can be expressed by the following equation (1). Note that k in the equation (1) denotes a proportionality factor.

P=k/R (1)

As an output of the far field microphone FFM, an output signal inversely proportional to the distance from the sound source is obtained according to the equation (1). On the other hand, an output proportional to a differential pressure between sound pressures received from the first sound hole 212 and the second sound hole 213 is obtained in the near field microphone NFM. With reference to FIGS. 5, 3A, and 3B, the output of the near field microphone NFM is described below in detail.

A distance between the first sound hole 212 and the second sound hole 213 of the near field microphone NFM is denoted by Δd. A case is described in which the microphone is disposed at a position close to the sound source. For instance, when the microphone is disposed so that a distance between the sound source and the first sound hole 212 is R1 and a distance between the sound source and the second sound hole 213 is R2, the differential pressure generated at the diaphragm 221a is P1−P2. In addition, a case is described in which the microphone is disposed at a position far from the sound source. For instance, when the microphone is disposed so that a distance between the sound source and the first sound hole 212 is R3 and a distance between the sound source and the second sound hole 213 is R4, the differential pressure generated at the diaphragm 221a is P3−P4. As described above, the output of the near field microphone NFM is equivalent to determining a gradient of a graph illustrated in FIG. 5, and hence characteristics equivalent to a differential with respect to the distance R can be obtained.

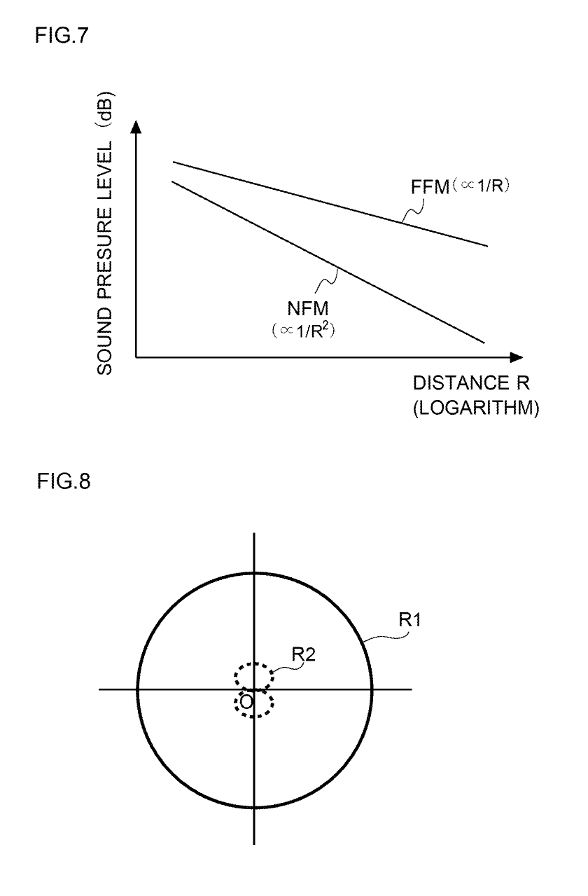

FIG. 7 is a graph for explaining distance attenuation characteristics of the near field microphone and the far field microphone, in which a horizontal axis represents the distance from the sound source R expressed as a logarithm, and a vertical axis represents a sound pressure level (dB) applied to the diaphragm of the microphone.

In the far field microphone FFM, because the diaphragm 321a is vibrated by the sound pressure applied to the upper surface, the output level of the microphone is attenuated by 1/R. On the other hand, in the near field microphone NFM, because the vibration is caused by a difference between sound pressures applied to the upper surface and the lower surface of the diaphragm 221a, the output level of the microphone is attenuated by 1/R² as the characteristics are obtained by differentiating characteristics of the far field microphone FFM with respect to the distance R.

As illustrated in FIG. 7, the output of the near field microphone NFM has a larger attenuation ratio to the distance from the sound source than the output of the far field microphone FFM. In other words, the near field microphone NFM collects sound generated in a vicinity of the microphone effectively, but sound in the far field is suppressed in comparison with the far field microphone FFM.

The sound pressure of sound generated in a vicinity of the near field microphone NFM is largely attenuated between the first sound hole 212 and the second sound hole 213. Therefore, a large difference occurs between the sound pressure transmitted to the upper surface of the diaphragm 221a and the sound pressure transmitted to the lower surface of the diaphragm 221a. On the other hand, sound from a far field sound source is hardly attenuated between the first sound hole 212 and the second sound hole 213, and hence a difference between the sound pressure transmitted to the upper surface of the diaphragm 221a and the sound pressure transmitted to the lower surface of the diaphragm 221a becomes very small. Note that it is supposed that the distance between the sound source and the first sound hole 212 is different from the distance between the sound source and the second sound hole 213.

Because a sound pressure difference of sound from a far field sound source received by the diaphragm 221a is very small, the sound pressure of sound from a far field sound source is substantially canceled by the diaphragm 221a. In contrast, because a sound pressure difference of sound from a near field sound source received by the diaphragm 221a is large, the sound pressure of sound from a near field sound source is not canceled by the diaphragm 221a. Therefore, a signal obtained by vibration of the diaphragm 221a is regarded as a signal of sound from a near field sound source.

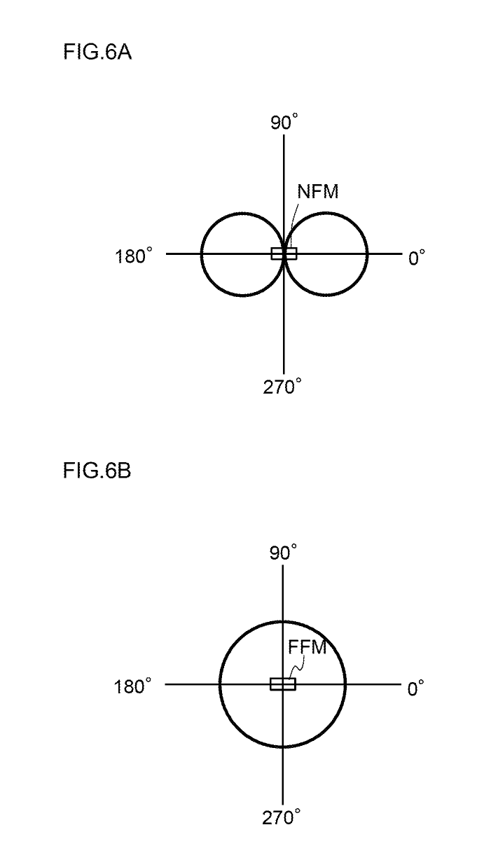

FIG. 6A illustrates directivity characteristics of the near field microphone NFM, and FIG. 6B illustrates directivity characteristics of the far field microphone FFM. FIG. 6A illustrates a case where the first sound hole 212 and the second sound hole 213 of the near field microphone NFM are arranged in directions of 0 degrees and 180 degrees. FIG. 6B illustrates a case where the sound hole 312 of the far field microphone FFM is disposed at a position of the origin.

First, directivity characteristics of the near field microphone NFM illustrated in FIG. 6A is described. If the distance between the sound source and the near field microphone NFM is constant, the sound pressure applied to the diaphragm 221a becomes highest when the sound source is disposed in the direction of 0 degrees or 180 degrees. This is because a difference between the distance from the sound source to the first sound hole 212 and the distance from the sound source to the second sound hole 213 becomes largest.

In contrast, the sound pressure applied to the diaphragm 221a becomes lowest (substantially zero) when the sound source is disposed in the direction of 90 degrees or 270 degrees. This is because the distance from the sound source to the first sound hole 212 becomes equal to the distance from the sound source to the second sound hole 213.

In other words, when the differential microphone of first-order gradient is used as the near field microphone NFM, the sensitivity becomes high for sound waves entering from directions of 0 degrees and 180 degrees, while the sensitivity becomes low for sound waves entering from directions of 90 degrees and 270 degrees, so as to show so-called bidirectional characteristics.

Next, directivity characteristics of the far field microphone FFM illustrated in FIG. 6B is described. If the distance from the sound source to the diaphragm 321a is constant, the sound pressure applied to the diaphragm 321a is constant regardless of the direction of the sound source. In other words, the far field microphone FFM shows non-directional characteristics in which sound waves entering from all directions are collected with uniform sensitivity.

With reference to FIG. 1 again, the sound signal processing portion 13 incorporated in the camera unit 1 is described. The sound signal processing portion 13 includes a first A/D converting portion 131 and a second A/D converting portion 132, each which converts an analog sound signal into a digital sound signal. The first A/D converting portion 131 performs a process of sampling the sound signal output from the near field microphone NFM (corresponding to the second sound signal of the present invention) at a predetermined period and converting the sampling result into a digital signal Y1(t). The second A/D converting portion 132 performs a process of sampling the sound signal output from the far field microphone FFM (corresponding to the first sound signal of the present invention) at a predetermined period and converting the sampling result into a digital signal Y2(t).

The sound signal processing portion 13 includes an independent component analysis (ICA) processing portion 133 that sequentially processes the digital signals output from the first A/D converting portion 131 and the second A/D converting portion 132 in a timesharing manner. As to a basic process of the ICA, a conventional technique is used. The ICA processing portion 133 performs a fast Fourier transform (FFT) process on the digital sound signals input from the two A/D converting portions 131 and 132, and then performs a process of determining a separating matrix using a technique of the independent component analysis in a frequency region (process of optimization). Here, the separating matrix is updated sequentially so that statistical independence between the separated signals is maximized and is processed to be converged into an optimal solution.

Sounds output from two independent sound sources at certain time point t are denoted by S1(t) and S2(t), respectively. In addition, the sounds (S1(t) and S2(t)) output from these sound sources are collected by two microphones. The signals obtained by A/D conversion of the sounds collected by the microphones are denoted by Y1(t) and Y2(t), respectively. In this case, the following equation (2) is satisfied.

$$( \begin{matrix}Y 1 ( t ) \\ \\ Y 2 ( t )\end{matrix} ) = A ( \begin{matrix}S 1 ( t ) \\ \\ S 2 ( t )\end{matrix} ) \qquad ( 2 )$$

Here, A represents a 2×2 mixing matrix.

When W is an inverse matrix of A, the following equation (3) is satisfied.

$$( \begin{matrix}S 1 ( t ) \\ \\ S 2 ( t )\end{matrix} ) = W ( \begin{matrix}Y 1 ( t ) \\ \\ Y 2 ( t )\end{matrix} ) \qquad ( 3 )$$

W in the equation (3) is the separating matrix, and the separating matrix W is optimized so that the statistical independence between the sounds S1(t) and S2(t) output from the two sound sources is maximized using the independent component analysis technique. Note that in this embodiment, the two independent sound sources correspond to the near field sound source disposed in a vicinity of the camera unit 1 and the far field sound source disposed at a position far from the camera unit 1 (a sound source other than the near field sound source). In addition, one of the two microphones corresponds to the near field microphone NFM, and the other corresponds to the far field microphone FFM.

The ICA processing portion 133 separates and extracts separated signals X1(t) and X2(t) from the sound signal received from the two microphones NFM and FFM (specifically, the signal after the process such as the A/D conversion and the like), by the optimized separating matrix W. Here, the separated signal X1(t) is a signal estimated as a signal of sound (S1(t)) from the near field sound source, which corresponds to the third sound signal of the present invention. In addition, the separated signal X2(t) is a signal estimated as a signal of sound (S2(t)) from the far field sound source, which corresponds to the fourth sound signal of the present invention.

The ICA processing portion 133 outputs the separated signal X2(t) estimated as the target sound to a sound recording portion 142 of the storing portion 14, and does not output the separated signal X1(t) estimated as noise to the sound recording portion 142. The sound recording portion 142 sequentially records the separated signal X2(t) sent from the ICA processing portion 133 in a timesharing manner.

Next, an action of the sound separating device 15 of the camera unit 1 having the above-mentioned structure is described.

FIG. 8 is a diagram illustrating directivity characteristics of the microphones incorporated in the camera unit of the embodiment of the present invention. In FIG. 8, the camera unit 1 is positioned at the center O. In FIG. 8, a solid line R1 indicates directivity characteristics of the far field microphone FFM, and an 8-shaped broken line R2 indicates directivity characteristics of the near field microphone NFM.

As described above, the near field microphone NFM is good at collecting sound from a near field sound source in a vicinity of the camera unit 1 (vicinity of the center O in FIG. 8), while the far field microphone FFM is good at collecting sound in a wide range including sound from a far field sound source far from the camera unit 1.

The near field microphone NFM is disposed so as to mainly collect sound (S1) generated in a vicinity of the camera unit 1, for example, mechanical sound generated from the main body 10 of the camera unit 1 (sound generated when the lens driving portion 112 drives the lens), operation sound generated when the operator operates the camera unit 1, and the voice of the operator. In addition, the far field microphone FFM is disposed so as to collect sound including ambient sound (S2) apart from the camera unit 1 in addition to the above-mentioned three sounds.

In this case, the output of the near field microphone NFM can be expressed as a1·S1+a2·S2, and the output of the far field microphone FFM can be expressed as a3·S1+a4·S2. Here, a1, a2, a3, and a4 are coefficients, and the condition that a1>>a2 is satisfied.

The ICA processing portion 133, which receives the signals from the input near field microphone NFM and the far field microphone FFM, separates and extracts the sound X1 estimated as sound S1 from a near field sound source and sound X2 estimated as sound S2 from a far field sound source using the separating matrix W optimized appropriately. In other words, according to the sound separating device 15 of this embodiment, it is possible to appropriately remove sound from a near field sound source considered conventionally to be undesired noise such as mechanical sound generated from the main body 10 of the camera unit 1, operation sound by the operator, and the voice of the operator, and hence only ambient sound apart from the camera can be obtained.

The conventional sound source separation technique is used mainly for separating two or more sound sources disposed in different directions from the microphone, and it is difficult to separate sound sources disposed in the same direction at different distances. This is because sounds from the sound sources enter the two microphones in the same phase. Therefore, in order to separate two or more sound sources, it is necessary to dispose the two microphones used for collecting sounds with a distance of 10 cm or larger between the microphones, and hence a large space is required for disposing the microphones.

On the other hand, using two microphones having different distance attenuation characteristics as in the structure of this embodiment, it is possible to secure a large amplitude difference from sound sources disposed in the same direction at difference distances so that it is possible to separate sound sources. Conventionally, sound sources are separated utilizing a difference of direction in the space. However, by using two microphones having different distance attenuation characteristics, it is possible to separate sound sources utilizing a difference of distance from the microphone. In addition, the structure of the present invention can separate sound sources even if the two microphones are disposed at the same position. Therefore, there is a merit that it is sufficient to secure the same space as the sizes of the microphones for disposing the two microphones.

The embodiment described above is merely an example of the present invention. In other words, the present invention is not limited to the embodiment described above, which can be modified variously in the scope of the present invention without deviating from technical spirit thereof.

For instance, in the embodiment described above, the near field microphone NFM and the far field microphone FFM have individual packages. However, it is preferred to dispose the near field microphone and the far field microphone close to each other as much as possible so that a phase shift between input sound waves is not generated. Therefore, it is preferred to adopt a structure in which the two microphones are formed in one package.

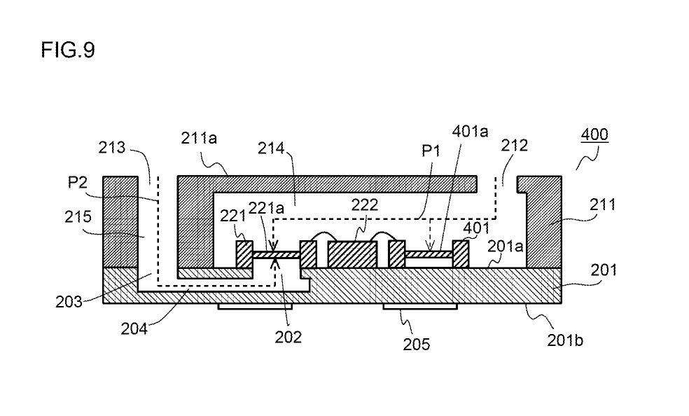

FIG. 9 is a diagram for explaining an exemplary variation of the embodiment of the present invention and is a schematic cross sectional view illustrating a structure in which the near field microphone and the far field microphone are formed in one package. Note that it is needless to say that the structure of the microphone of this exemplary variation is merely an example and can be modified variously. In short, it is sufficient that the structure of one package can show the function of the near field microphone and the function of the far field microphone.

The structure of a microphone 400 of the exemplary variation illustrated in FIG. 9 is almost the same as the structure of the near field microphone NFM illustrated in FIG. 3. The different point is that a MEMS chip 401 (having the same structure as the MEMS chip 221) is added to the structure of the microphone illustrated in FIG. 3. Note that in FIG. 9, the same part as that of the microphone that is illustrated in FIG. 3 is denoted by the same numeral.

When a sound is generated outside the microphone 400, the sound wave entering from the first sound hole 212 reaches the upper surface of a diaphragm 401a of the second MEMS chip 401 through the first sound channel P1 so that the diaphragm 401a is vibrated. The diaphragm 401a of the second MEMS chip 401 is vibrated only by the sound wave applied to the upper surface, and the signal output from the second MEMS chip 401 is used so that the same function as the far field microphone FFM of the embodiment described above can be obtained.

In addition, when a sound is generated outside the microphone 400, the sound wave entering from the first sound hole 212 reaches the upper surface of the diaphragm 221a of the first MEMS chip 221 through the first sound channel P1, and the sound wave entering from the second sound hole 213 reaches the lower surface of the diaphragm 221a of the first MEMS chip 221 through the second sound channel P2. Therefore, the diaphragm 221a of the first MEMS chip 221 is vibrated by a sound pressure difference between the sound pressure applied to the upper surface and the sound pressure applied to the lower surface. Therefore, using the signal output from the first MEMS chip 221, the same function as the near field microphone NFM of the embodiment described above can be obtained.

In addition, the embodiment described above has a structure in which the sound signal processing portion (ICA processing portion) 13 of the sound separating device 15 optimizes the separating matrix W regardless of the drive or non-drive state of the lens driving portion 112. However, if optimization of the separating matrix W is always performed, the optimization process of the separating matrix W is performed also in a state where the lens driving portion as a main noise source does not operate. Therefore, the separating matrix W may be converged into an abnormal value or may be diverged. In order to prevent this, it is preferred to perform the optimization of the separating matrix W when the lens driving portion 112 operates (when mechanical sound is generated), and not to perform the optimization of the separating matrix W when the lens driving portion 112 does not operate (when mechanical sound is not generated).

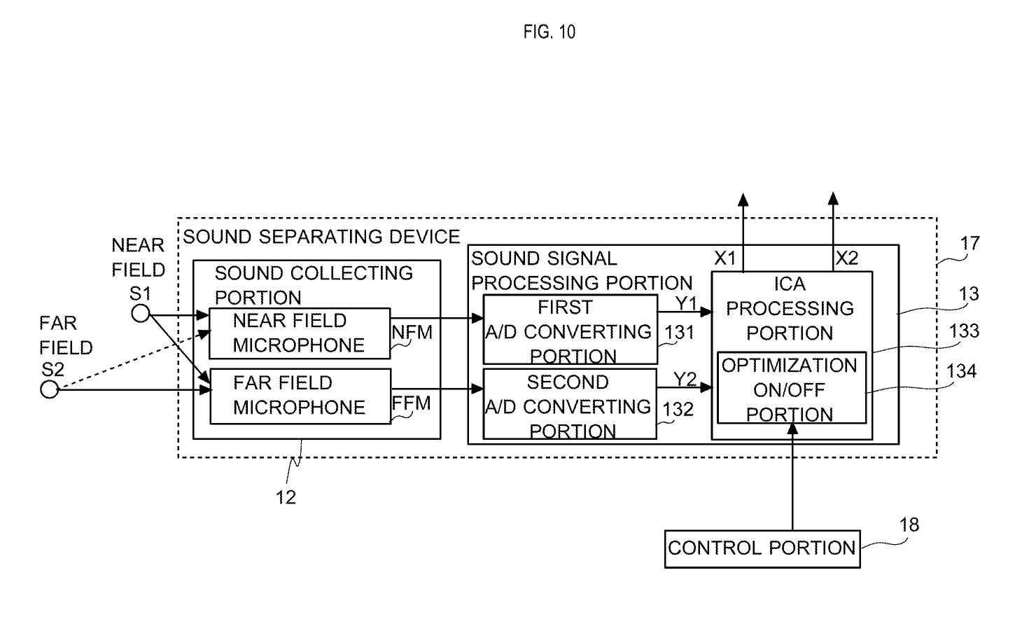

FIG. 10 is a diagram for explaining an exemplary variation of the embodiment of the present invention and is a block diagram of a sound separating device having a structure in which execution or non-execution of the optimization of the separating matrix can be switched by the drive or non-drive state of the lens driving portion. As illustrated in FIG. 10, a sound separating device 17 of the exemplary variation has a structure in which an optimization ON/OFF portion 134 is added to the ICA processing portion 133 of the sound separating device 15 according to the embodiment described above.

The optimization ON/OFF portion 134 is electrically connected to a control portion 18 of the camera unit 1. This control portion 18 also controls the lens driving portion 112 and grasps the drive or non-drive state of the lens driving portion 112. When the control portion 18 informs the optimization ON/OFF portion 134 of information to drive the lens driving portion 112, similarly to the case of the embodiment described above, the ICA processing portion 133 separates and extracts the sound signals while performing optimization of the separating matrix W. On the other hand, when the control portion 18 informs the optimization ON/OFF portion 134 of information not to drive the lens driving portion 112, the ICA processing portion 133 does not perform the optimization of the separating matrix W and holds the value of the separating matrix W. Thus, the ICA process can be performed stably.

In this sound separating device 17, mechanical sound generated from the camera unit 1 among sounds from the near field sound sources is effectively separated and extracted while the voice of the operator is not separated but is extracted as target sound together with sound from the far field sound source. When a moving image is taken by the camera unit 1, it is considered that there is a request not to remove the voice of the operator, and this exemplary variation is suitable for supporting such a request.

In addition, in the embodiment described above, the microphones NFM and FFM incorporated in the camera unit 1 are MEMS microphones made by using a semiconductor manufacturing process. However, the present invention is not limited to this structure. For instance, the microphone may be a capacitive microphone (ECM) using an electret membrane. In addition, the microphones NFM and FFM incorporated in the camera unit 1 are not limited to a so-called capacitive microphone but may be a dynamic, magnetic, or piezoelectric microphone, for example.

In addition, in the embodiment described above, the near field microphone NFM is constituted as a differential microphone having only one diaphragm 221a. However, the present invention is not limited to this structure. In other words, the near field microphone may be a differential microphone having two diaphragms, for example, which outputs a difference between signals output based on the individual diaphragms as the sound signal.

In addition, in the embodiment described above, the near field microphone NFM is constituted as the differential microphone of first-order gradient. However, the present invention is not limited to this structure. In other words, the near field microphone may be a differential microphone having second-order or third-order gradient characteristics.

In addition, in the embodiment described above, the far field microphone FFM is the non-directional microphone. However, the present invention is not limited to this structure. The far field microphone may be a directivity microphone such as a unidirectional microphone or the like. This structure is effective, for example, in a case where the direction of sound to be collected is limited to a specific direction when a moving image is taken by the camera unit 1.

Other than that, in the above description, the sound separating device of the present invention is applied to the camera unit. However, the sound separating device of the present invention can be applied widely to cases where sound from a near field sound source should be separated from sound from a far field sound source, and the application may include electronic devices other than a camera unit, for example, a mobile phone in use for separating background noise. When applied to a mobile phone, the near field microphone NFM is disposed to catch the voice of a person speaking, and the far field microphone FFM is disposed to catch sound including background noise, and hence the voice of the person speaking can be separated from the background noise.

What is claimed is:

1. A sound separating device comprising:
a first microphone that converts input sound into a first sound signal;
a second microphone that converts input sound into a second sound signal and has characteristics of a larger distance attenuation ratio than the first microphone; and
a sound signal processing portion that optimizes a separating matrix by independent component analysis based on the first sound signal and the second sound signal that are supplied, and uses the optimized separating matrix so as to separate a third sound signal as a sound signal from a near field sound source and to separate a fourth sound signal as a sound signal from a far field sound source.

2. The sound separating device according to claim 1, wherein the second microphone is a differential microphone.

3. The sound separating device according to claim 2, wherein the differential microphone has first-order gradient characteristics.

4. The sound separating device according to claim 2, wherein the differential microphone includes only one diaphragm vibrated by sound pressure.

5. The sound separating device according to claim 1, wherein the first microphone is a non-directional microphone.

6. The sound separating device according to claim 1, wherein the first microphone and the second microphone are formed in one package.

7. A sound separating device comprising:
a first microphone that converts input sound into a first sound signal;
a second microphone that converts input sound into a second sound signal and has characteristics of a larger distance attenuation ratio than the first microphone; and
a sound signal processing portion that optimizes a separating matrix by independent component analysis based on the first sound signal and the second sound signal that are supplied, and uses the optimized separating matrix so as to separate a third sound signal as a sound signal from a near field sound source and to separate a fourth sound signal as a sound signal from a far field sound source, wherein
the first microphone is a non-directional microphone, and
the second microphone is a differential microphone including only one diaphragm vibrated by sound pressure and has first-order gradient characteristics.

8. A camera unit comprising a sound separating device, wherein the sound separating device includes:
a first microphone that converts input sound into a first sound signal;
a second microphone that converts input sound into a second sound signal and has characteristics of a larger distance attenuation ratio than the first microphone; and
a sound signal processing portion that optimizes a separating matrix by independent component analysis based on the first sound signal and the second sound signal that are supplied, and uses the optimized separating matrix so as to separate a third sound signal as a sound signal from a near field sound source and to separate a fourth sound signal as a sound signal from a far field sound source.

9. The camera unit according to claim 8, further comprising:
an image pickup portion that photographs a subject and converts the photographed information into an image signal; and
a storing portion that stores the image signal and the fourth sound signal.

10. The camera unit according to claim 9, wherein
the image pickup portion includes a lens portion that forms an image of incident light from the direction of the subject and a lens driving portion that drives a movable lens included in the lens portion, and
the sound signal processing portion performs optimization of the separating matrix in a period while the lens driving portion is operating, and does not perform the optimization of the separating matrix in a period while the lens driving portion does not operate.
